(19) United States
(12) Patent Application Publication
(10) Pub. No.: US 2020/0290916 A1
(43) Pub. Date: Sep. 17, 2020

(54) SYSTEMS AND METHODS FOR PROCESSING THIN GLASS RIBBONS

(71) Applicant: Corning Incorporated, Corning, NY (US)

(72) Inventor: Antoine Gaston Denis Bisson, Bois le Roi (FR)

(21) Appl. No.: 16/760,749

(22) PCT Filed: Oct. 30, 2018
(86) PCT No.: PCT/US2018/058124

§ 371 Date: Apr. 30, 2020

Related U.S. Application Data
(60) Provisional application No. 62/618,259, filed on Jan. 17, 2018.
(60) Provisional application No. 62/579,543, filed on Oct. 31, 2017.

(51) Int. Cl. C03B 17/06; B65H 23/24; B65H 20/00; C03B 35/24

(52) U.S. Cl. CPC C03B 17/068; B65H 23/24; C03B 35/16; C03B 35/246; C03B 17/064; B65H 20/00

(57) ABSTRACT

Systems, apparatuses and methods for processing a glass ribbon (22). A glass ribbon is supplied to an upstream side of a conveying apparatus (32). A pulling force is applied on the glass ribbon (22) at a downstream side of the conveying apparatus (32). The glass ribbon (22) is supported at first and second support devices along a travel path of the conveying apparatus (32). Each of the first and second support devices (72) establishes a non-rolling, line-type interface with the glass ribbon (22). Further, the first support device (72a) is spaced from the second support device (72c) along the travel path. In some embodiments, the line-type interface comprises a sliding interface or a gas bearing interface.

### CROSS-REFERENCE TO RELATED APPLICATIONS

This application claims the benefit of priority under 35 U.S.C. § 119 of U.S. Provisional Application Ser. No. 62/579,543 filed Oct. 31, 2017 and U.S. Provisional Application Ser. No. 62/618,259 filed Jan. 17, 2018, the content of each are relied upon and incorporated herein by reference in their entirety.

### BACKGROUND

### Field

The present disclosure generally relates to systems and methods for processing a glass ribbon. More particularly, it relates to systems and methods for handling a glass ribbon as part of the manufacture of thin glass sheets from a moving glass ribbon.

### Technical Background

Production of glass sheets typically involves producing a glass ribbon from a molten glass material, and then cutting or separating individual glass sheets from the glass ribbon. Various techniques are known for producing the glass ribbon. For example, with a down-draw process (e.g., fusion draw process), the ribbon is drawn downward, typically from a forming body. Other glass making processes include, for example, float, up-draw, slot-style and Fourcault's-style processes. In yet other examples, the glass ribbon can be temporarily stored in roll form, and later unwound for subsequent cutting or separation of individual glass sheets.

To meet the demands of many end use applications, continuing efforts have been made to produce thinner glass sheets (e.g., about 1 millimeter (mm) or less). As the thickness of the glass ribbons from which the glass sheets are formed becomes thinner, they are also more susceptible to warp (or flatness deviations) and other concerns (such as surface damage that may be imparted during the process steps to provide a thinner glass ribbon). Warp can occur in one or more of the width or length direction of the glass ribbon. During the glass forming process, a glass ribbon is first formed in a viscous state, and is then cooled to a viscoelastic state and finally to an elastic state. With some thin rolled glass formation techniques, the process layout includes transitioning the glass ribbon from a vertical orientation to a horizontal orientation, and then conveying in the horizontal orientation within a controlled cooling environment. When the glass ribbon is thin and still at low viscosity, it can be very easy to generate in-plane local stresses that in turn can induce out-of-plane deformation (e.g., buckling).

For example, a typical practice is to convey the glass ribbon on a series of driven rollers. To be viable, there normally is some friction between surface(s) of the glass ribbon and the driven roller in order to impart a driving force and direction. Rollers inherently may not have perfect alignment with the glass ribbon travel direction, and may not have perfectly matched linear velocities. The resulting effects are differential steering and pulling that can induce stresses that may cause deformation. A local deformation can be the result of a local tensile force or compressive stress. In addition to possibly generating some stretching at low viscosities, tensile stresses may also cause local slippage and potentially scratches.

As an alternative to driven rollers, air bearings have been considered for glass ribbon transport. In principle, an air bearing surface can serve to prevent direct contact between the hot glass ribbon and a cold tooling surface. In the context of thick glass ribbon transport, available air bearing conveyor devices may address some issues associated with driven roller conveyance. However, with available air bearing conveyor devices, an intrinsic limitation exists at the edges of the air bearing device where the air bearing effect diminishes, resulting in direct contact with a support of the air bearing conveyor device. Local cooling by direct contact can be a distinct concern in the context of thin glass ribbons given the small thermal mass of the glass ribbon and the comparatively large heat transfer generated at the point of contact, potentially resulting in an oscillating condition that materializes in a wavy ribbon edge, as well as other possible forms of deformation in the traveling glass ribbon.

Regardless of the source, the deformation(s) described above may become “frozen” in the final product as the glass ribbon cools. A flatter glass ribbon reduces the amount of material that may need to be removed, such as by grinding and/or polishing, to achieve a given final thickness. For example, flatness on the order of 100 micrometers (for a sheet size of about 250 mm×600 mm) may be necessary for some applications.

The common practice to minimize warp is to pass the glass ribbon through nip rolls at a location close to the end of the purely viscous regime. Nip rolls are cylindrical and can be set at a fixed gap or at a fixed pinch force. Typically one of the two nip rolls is driven and the other is idle to apply a desired force. Regardless, the mechanical effect applied to the glass ribbon by the nip rolls is essentially unidirectional (a “squeezing” effect) and characterized as a short line or linear mode of contact. For some end use applications, the linear contact applied by the nip rolls alone cannot achieve a desired level of flatness.

Accordingly, systems and methods for processing a glass ribbon, for example reducing occurrences of out-of-plane deformation in a glass ribbon, are disclosed herein.

### SUMMARY

Some embodiments of the present disclosure relate to a method for processing a glass ribbon. A glass ribbon is supplied to an upstream side of a conveying apparatus. A pulling force is applied on the glass ribbon at a downstream side of the conveying apparatus. The glass ribbon is supported at first and second support devices along a travel path of the conveying apparatus from the upstream side to the downstream side. In this regard, each of the first and second support devices establishes a non-rolling, line-type interface with the glass ribbon. In some embodiments, a “line-type interface” is in reference to the glass ribbon being fully supported across its width by a device that has an effective contact surface as small as possible. A glass ribbon can be assimilated to a planar surface, so for example a cylindrical shaped support device would be considered as creating a line-type interface or contact with the glass ribbon. The first support device is spaced from the second support device along the travel path. In some embodiments, between at least one of the first and second support devices, the line-type interface comprises a sliding interface. In other embodiments, between at least one of the first and second support devices, the line-type interface comprises a gas bearing interface. In some embodiments, the first support device is spaced from the second support device along the travel path by a distance of not less than 50 mm, with the glass ribbon not being directly supported by the conveying apparatus between the first and second support devices.

Yet other embodiments of the present disclosure relate to a system for processing a glass ribbon. The system comprises a conveying apparatus configured to establish a travel path for the glass ribbon from an upstream side to a downstream side. The conveying apparatus comprises a pulling device, a first support device, and a second support device. The pulling device is configured to apply a pulling force onto the glass ribbon, and is located proximate the downstream side. The first support device is upstream of the pulling device relative to the travel path. The second support device is between the first support device and the pulling device relative to the travel path. The first and second support devices are each configured to establish a no-rolling, line-type interface with the glass ribbon. Further, the first support device is spaced from the second support device along the travel path. In some embodiments, at least one of the first and second support devices comprises a contact surface having a low coefficient of friction with glass that is arranged to establish sliding contact with the glass ribbon. In some embodiments, “a low coefficient of friction with glass” relates to an ability of the body to support the glass ribbon without imparting visually discernable surface scratches at expected travel speeds. Some materials that are considered to have a low coefficient of friction with glass in accordance with principles of the present disclosure include, but are not limited to, graphite, boron nitride, and smooth silicon carbide (Ra<1 micron). In some embodiments, at least one of the first and second support devices comprises a gas bearing support device. In some embodiments, the system further comprises a glass ribbon forming apparatus arranged to deliver a glass ribbon to the upstream side.

Additional features and advantages will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate various embodiments described herein, and together with the description serve to explain the principles and operations of the claimed subject matter.

### BRIEF DESCRIPTION OF THE DRAWINGS

FIG. 1 is a simplified side view of a system processing a glass ribbon in accordance with principles of the present disclosure, the system including a conveying apparatus;

FIG. 2 is a simplified top view of a portion of the conveying apparatus of the system of FIG. 1 processing a glass ribbon;

FIG. 3A is a side view of a support device in accordance with principles of the present disclosure and useful with the conveying apparatus of FIG. 1 processing a glass ribbon;

FIG. 3B is a side view of a support device in accordance with principles of the present disclosure and useful with the conveying apparatus of FIG. 1 processing a glass ribbon;

FIG. 3C is a side view of a support device in accordance with principles of the present disclosure and useful with the conveying apparatus of FIG. 1 processing a glass ribbon;

FIG. 4A is a simplified cross-sectional view of a support device in accordance with principles of the present disclosure and useful with the conveying apparatus of FIG. 1;

FIG. 4B is a simplified end view of the support device of FIG. 4A;

FIG. 4C is an enlarged view of a portion of the support device of FIG. 4A along the segment 4C;

FIG. 5A is a simplified cross-sectional view of the support device of FIG. 4A interfacing with a glass ribbon; and

FIG. 5B is a simplified end view of the arrangement of FIG. 5A.

### DETAILED DESCRIPTION

Reference will now be made in detail to various embodiments of systems and methods for processing a glass ribbon, and in particular for removing warp from, or improving flatness in, a glass ribbon, for example a continuous glass ribbon. Whenever possible, the same reference numerals will be used throughout the drawings to refer to the same or like parts.

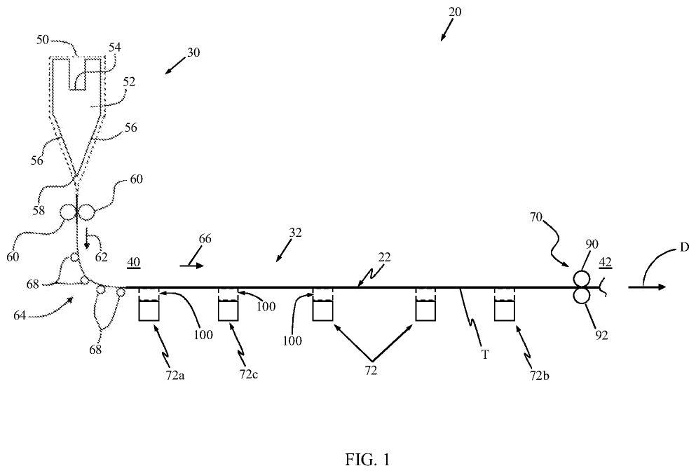

Some aspects of the present disclosure provide glass ribbon handling systems and methods in which a continuously conveyed or traveling glass ribbon is subjected to a cooling environment and is supported in such a way that desired flatness is minimally affected, if at all. With this in mind, one embodiment of a system 20 in accordance with principles of the present disclosure and useful in forming and processing a glass ribbon 22 is schematically shown in FIG. 1. Although the system 20 is described herein as being used to process a glass ribbon, it should be understood that the systems and methods of the present disclosure can also be used to process other types of materials such as polymers (e.g., Plexi-Glass™), metals, or other substrate materials.

The system 20 includes a glass ribbon supply apparatus 30 and a conveying apparatus 32. As described in greater detail below, the glass ribbon supply apparatus 30 can assume a wide variety of forms appropriate for generating and delivering the glass ribbon 22 to an upstream side 40 (referenced generally) of the conveying apparatus 32. The conveying apparatus 32 causes the glass ribbon 22 to travel from the upstream side 40 to a downstream side 42 (referenced generally). The glass ribbon 22 cools in an environment of the conveying apparatus 32 and thus experiences an increasing viscosity from the upstream side 40 to the downstream side 42.

In some non-limiting embodiments, such as illustrated in FIG. 1, the glass ribbon supply apparatus 30 incorporates fusion processes in which molten glass 50 is routed to a forming body 52. The forming body 52 comprises an open channel 54 positioned on an upper surface thereof, and a pair of converging forming surfaces 56 that converge at a bottom or root 58 of the forming body 52. The molten glass 50 flows into the open channel 54 and overflows the walls thereof, thereby separating into two individual flow of molten glass that flow over the converging forming surfaces 56. When the separate flow of molten glass reach the root 58, they recombine, or fuse, to form a single ribbon of viscous molten glass (i.e., the glass ribbon 22) that descends from the root 58. Various rollers 60 contact the viscous glass ribbon 22 along the edges of the ribbon and aid in drawing the ribbon 22 in a first, downward direction 62 (such as a vertical direction). The present disclosure is equally applicable to other variations of down draw glass making processes such as a single sided overflow process or a slot draw process, which basic processes are well known to those skilled in the art.

In some embodiments, the glass ribbon supply apparatus 30 can further include a redirecting device 64 that redirects the glass ribbon 22 from the first direction 62 into a second direction 66 for delivery to the conveying apparatus 32. The redirecting device 64 is represented in FIG. 1 by rollers 68. In some embodiments, the glass ribbon 22 is turned by the redirecting device 64 through an angle of about 90 degrees and the second direction 66 is substantially horizontal (i.e., within 5 degrees of a truly horizontal orientation relative to the earth). In some embodiments, the redirecting device 64 does not physically contact the glass ribbon 22 (e.g., air bearings), or, in the event that contact is necessary, such as when rollers are used, contact can be limited to the edge portions of the glass ribbon 22.

Other glass ribbon formation techniques are also acceptable that may or may not include the 90 degree turn described above, may or may not incorporate fusion processes, etc. Regardless, the molten, viscous glass ribbon 22 is continuously supplied to the upstream side 40 of the conveying apparatus 32.

The conveying apparatus 32 includes a pulling device 70 and two or more discrete, spaced-apart support devices 72. In general terms, the pulling device 70 is located at or immediately proximate the downstream side 42, and exerts a pulling force onto the glass ribbon 22 to continuously convey the glass ribbon 22 along a travel path T defined, at least in part, by the support devices 72 as described below. While five of the support devices 72 are shown, any other number, either greater or lesser (including two) is equally acceptable. Thus, the conveying apparatus 32 includes at least an upstream-most support device 72a and a downstream-most support device 72b. In some non-limiting embodiments, the conveying apparatus 32 is configured for installation to the floor of a glass production facility, and thus can include framework (not shown) supporting one or more of the pulling device 70, the support devices 72, and other optional components such as rollers (or other transport devices) adjacent the pulling device 70 as are known in the art.

The pulling device 70 can assume a variety of forms appropriate for driving or pulling the glass ribbon 22, and in some embodiments can be or can include a conventional nip roll device comprising first and second rollers 90, 92. One or both of the rollers 90, 92 can be a driven roller as is known in the art. With these and similar configurations, the pulling device 70 can further include a controller (not shown), for example a computer-like device, programmable logic controller, etc., programmed to control a speed or travel rate of the glass ribbon 22 along the conveying apparatus 32. Other pulling device configurations are also acceptable.

The support devices 72 can assume various forms as described below and can be located at various positions between the upstream side 40 and the downstream side 42 for interfacing with and supporting the glass ribbon 22 along the travel path T. In general terms, a configuration and a location of each of the support devices 72 are selected to support the traveling glass ribbon 22 with a non-rolling (e.g., sliding), line-type interface as a function, in some non-limiting embodiments, of an expected viscosity and/or temperature of the glass ribbon 22 at the point of interface with each particular one of the support devices 72 (it being recalled that in some embodiments, a temperature of the glass ribbon 22 decreases, and a viscosity of the glass ribbon 22 increases, from the upstream side 40 to the downstream side 42). In some embodiments, a “line-type interface” is in reference to the glass ribbon 22 being fully supported across its width by the support device 72 that otherwise has an effective interface or contact surface as small as possible. The glass ribbon 22 can be assimilated to a planar surface, so for example a cylindrical shaped support device 72 would be considered as creating a line-type interface or contact with the glass ribbon 22.

One or more of the support devices 72 is or includes a stationary, low friction body establishing a sliding interface with the traveling glass ribbon 22. Alternatively or in addition, one or more of the support devices 72 is or includes a gas bearing device operable to direct gas at the glass ribbon 22, thus generating or forming a gas film or layer that supports the traveling glass ribbon 22. With either construction, a non-rotating support zone or region 100 is established by each of the support devices 72 and at which the glass ribbon 22 is directly supported. In the simplified illustration of FIG. 1, the support zone 100 of each of the support devices 72 is drawn with a dashed line to reflect that the support zone 100 can be a material body (e.g., as with embodiments in which the support device 72 is or includes a low friction body that is in direct, physical contact with the glass ribbon 22) or can be a gas film (e.g., as with embodiments in the support device 72 is or includes a gas bearing device and with which the gas film exists upon operation of the gas bearing device). The travel path T as collectively established by the support devices 72 (as the glass ribbon 22 is being pulled by the pulling device 70) is thus relative to the corresponding support zones 100, it being understood that where a particular one of the support devices 72 is a gas bearing device, the corresponding support zone 100 does not physically exist unless the support device 72 is operated to direct a flow of gas at the glass ribbon 22.

The discrete, spaced-apart arrangement of the support devices 72 is in reference to the conveying apparatus 32 not directly supporting the glass ribbon 22 between successive support devices 72. For example, with respect to the non-limiting example of FIG. 1, the glass ribbon 22 is not directly, physically supported by the conveying apparatus 32 between the support zone 100 of the upstream-most support device 72a and the support zone 100 of a first intermediate support device 72c that otherwise successively follows the upstream-most support device 72a along the travel path T. Alternatively stated, the support devices 72 each exert a normal force onto the glass ribbon 22 that supports the weight of the glass ribbon 22; between successive support devices 72, the conveying apparatus 32 does not exert a normal force onto the glass ribbon 22 and thus the glass ribbon 22 is not directly supported by the conveying apparatus 32 between successive support devices 72. The spaced-apart arrangement promotes a line-type interface with the glass ribbon 22 at each of the support zones 100 as described in greater detail below. With this in mind, the travel path T of the glass ribbon 22 along the conveying apparatus 32 is schematically shown in FIG. 1 as being linear or planar (e.g., the glass ribbon 22 is linear or planar between the upstream-most support device 72a and the pulling device 70), including at locations between the support zones 100 of successive discrete, spaced-apart support devices 72. It will be understood that FIG. 1 reflects an instant in time of the otherwise traveling glass ribbon 22. Due to the discrete, spaced-apart configuration and arrangement of the support devices 72 as well as the horizontal orientation of the glass ribbon 22, absent a pulling force being applied by the pulling device 70 (i.e., were the glass ribbon 22 to be stationary or not moving) and under circumstances where the glass ribbon 22 has a relatively low viscosity, a catenary would likely form in the glass ribbon 22 (i.e., the glass ribbon 22 would likely sag or stretch) between successive support devices 72 under the force of gravity. Under normal operating conditions, the pulling force applied by the pulling device 70 creates tension in the glass ribbon 22 that in turn lessens the effects of gravity on the glass ribbon 22 between successive support devices 72.

While in theory occurrences of catenaries could be eliminated, with the methods, systems and apparatuses of the present disclosure, a slight catenary may be formed in the glass ribbon 22 between successive ones of the support devices 72 under normal (and expected) operating conditions and is acceptable. The amplitude or level of a catenary between two successive support devices 72 is a function of the viscosity of the glass ribbon 22, the pulling force, and the spacing between the successive support devices 72. In some embodiments, based upon expected glass ribbon viscosity and pulling force parameters, a spacing between successive ones of the support devices 72 is selected to limit the catenary amplitude to less than 20 mm. For example, in some embodiments, a spacing between successive support devices 72 (and in particular between the respective support zones 100 of successive support device 72) is in the range of 100-500 mm, although other spacing parameters are envisioned. This optional spacing range can be appropriate, for example, where an expected viscosity of the glass ribbon 22 at the upstream side 40 is less than 10⁸ Poise and the pulling device 70 is operated to move the glass ribbon 22 at a velocity in the range of 1-20 meters/minute (m/min), optionally at a velocity of 10-15 m/min Moreover, with embodiments in which the conveying apparatus 32 provides three or more of the support devices 72, a spacing between consecutive support devices 72 need not be uniform. For example, where the expected viscosity of the glass ribbon 22 increases toward the downstream side 42, a spacing between the support zones 100 of successive support devices 72 can increase in the downstream direction (e.g., a spacing between the support zones 100 of successive support devices 72 near the downstream side 42 can be greater than a spacing between successive support devices 72 near the upstream side 40). Regardless, in some embodiments a spacing along the travel path T between the support zones 100 of successive support devices 72 is not less than 50 mm, optionally not less than 100 mm, to better promote a line-type interface with the glass ribbon 22.

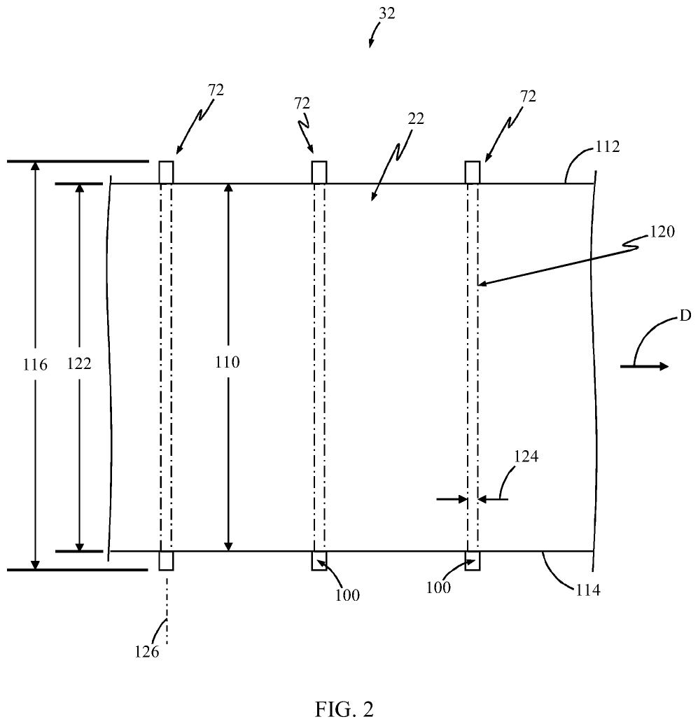

As a point of reference, FIG. 1 identifies a direction of travel D of the glass ribbon 22 as dictated by operation of the pulling device 70. The simplified top view of FIG. 2 identifies this same direction of travel D, along with several of the support devices 72. The glass ribbon 22 has a cross-web dimension 110 that is perpendicular to the direction of travel D, defined as a distance between opposing side edges 112, 114. The support devices 72 are each configured such that the corresponding support zone 100 has a major dimension 116 that is greater than the expected cross-web dimension 110, and are each arranged such that the corresponding support zone 100 extends beyond the side edges 112, 114. As previously described, the glass ribbon 22 is directly supported by the conveying apparatus 32 at each of the support zones 100, and is free of direct support by the conveying apparatus 32 between the support zones 100 of successive support devices 72. Depending upon a size, viscosity, and rate of travel of the glass ribbon 22, as well as a configuration of each particular support device 72, the glass ribbon 22 may not directly interface with an entirety of an available area of the corresponding support zone 100. As such, FIG. 2 represents an interface region 120 for each of the support devices 72 and at which the glass ribbon 22 is directly supported by the corresponding support zone 100. In the representation of FIG. 2, a shape of the interface region 120 can be viewed as having a length 122 and a width 124, and mimics a shape of the corresponding support zone 100. In some embodiments, the width 124 can be substantially uniform (i.e., within 5% of a truly uniform width) across the length 122. Regardless, the line-type interface can include the length 122 of one or more or all of the interface regions 120 being at least 10 times greater than the corresponding width 124, alternatively at least 20 times greater. In some non-limiting embodiments, the line-type interface can include one or more or all of the support devices 72 being configured such that the width 124 of the resultant interface region 120 is less than 20 mm. The elongated shape of the interface region 120 generated by one or more or all of the support devices 72 can also be viewed as defining a centerline 126 (e.g., where the interface region 120 has the substantially uniform width 124, the corresponding centerline 126 will be substantially parallel (i.e., within 5 degrees of a truly parallel arrangement) with the length 122). In some embodiments, one or more or all of the support devices 72 are arranged such that the centerline 126 of the corresponding interface region 120 is substantially perpendicular (i.e., within 5 degrees of a truly perpendicular arrangement) to the direction of travel D.

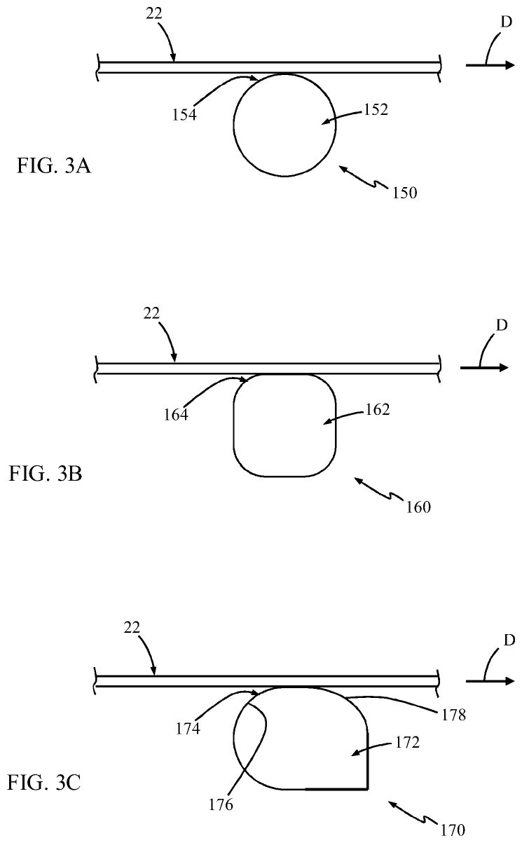

Returning to FIG. 1 and with the above-described features in mind, in some embodiments one or more of the support devices 72 provided with the conveying apparatus 32 is or includes a material having a low coefficient of friction with glass and arranged to establish sliding contact with the glass ribbon 22 along the travel path T. For example FIG. 3A illustrates a sliding contact support device 150 useful as, or as part of, one or more of the support devices 72 (FIG. 1) of the present disclosure. The support device 150 includes a body 152 forming or carrying a contact surface 154. The contact surface 154 serves as the support zone 100 (FIG. 1) as previously described, and is formed of a material having a low coefficient of friction with glass. In some embodiments, “a low coefficient of friction with glass” relates to an ability of the body 152 to support the glass ribbon 22 at the contact surface 154 without imparting visually discernable surface scratches at expected travel speeds. Some materials that are considered to have a low coefficient of friction with glass in accordance with principles of the present disclosure include, but are not limited to, graphite, boron nitride, smooth silicon carbide (Ra<1 micron), and the like. In some embodiments, the contact surface 154 is integrally formed by the body 152 (i.e., the body 152 is formed of the selected low friction coefficient material). In other embodiments, the body 152 and the contact surface 154 are formed of differing materials, with the selected low friction coefficient material being applied to the body 152 to create the contact surface 154. For example, graphite is a material having a very low fiction behavior on glass, and is relatively inexpensive and easy to machine. In some embodiments and with additional reference to FIG. 1, the contact surface 154 can be a graphite material (and/or the body 152 can be a graphite material body) where, for example, the expected temperature of the glass ribbon 22 along the travel path T at the region of interface with the contact surface 154 is less than about 450 degrees Celsius (° C.). In some embodiments, the contact surface 154 can be a sintered alpha silicon carbide material (and/or the body 152 can be a sintered alpha silicon carbide material body) where, for example, the expected viscosity of the glass ribbon 22 along the travel path T at the region of interface with the contact surface 154 is in the range of 5×10⁶-5×10⁷ Poise.

Regardless of the exact material employed, the body 152 can have the right cylinder shape reflected by FIG. 3A such that at least a portion of the contact surface 154 is curved (e.g., the contact surface 154 can define or incorporate a convex curvature relative to the glass ribbon 22). Other shapes are also acceptable. For example, another embodiment sliding contact support device 160 useful as, or as part of, one or more of the support devices 72 (FIG. 1) of the present disclosure is shown in FIG. 3B. The support device 160 includes a body 162 forming or carrying a contact surface 164. The contact surface 164 serves as the support zone 100 (FIG. 1) as previously described, and is formed of a material having a low coefficient of friction with glass as described above. The contact surface 164 can be integrally formed by the body 162 (i.e., the body 162 is formed of the selected low friction coefficient material), or can be applied to the body 162 (i.e., the body 162 and the contact surface 164 are formed of differing materials, with the selected low friction coefficient material being applied to the body 162 to create the contact surface 164). Regardless, a transverse shape of the body 162 can be a square with rounded corners as shown such that at least a portion of the contact surface 164 is curved.

Another embodiment sliding contact support device 170 useful as, or as part of, one or more of the support devices 72 (FIG. 1) of the present disclosure is shown in FIG. 3C. The support device 170 and includes a body 172 forming or carrying a contact surface 174. The contact surface 174 serves as the support zone 100 (FIG. 1) as previously described, and is formed of a low friction coefficient material as described above. The contact surface 174 can be integrally formed by the body 172 (i.e., the body 172 is formed of the selected low friction coefficient material), or can be applied to the body 172 (i.e., the body 172 and the contact surface 174 are formed of differing materials, with the selected low friction coefficient material being applied to the body 172 to create the contact surface 174). Regardless, the body 172 can have a complex transverse shape such that at least a portion of the contact surface 174 is curved. More particularly, the contact surface 174 has a first side 176 opposite a second side 178. The support device 170 is arranged such that when moving in the direction of travel D, the glass ribbon 22 contacts or interfaces with the first side 176 followed by the second side 178. While the first and second sides 176, 178 of the contact surface 174 can both be curved, a radius of curvature of the first side 176 is less than (or “tighter”) than that of the second side 178 to minimize the potential contact area. In related embodiments, one or both of the sides 176, 178 can define a 90 degree corner.

Regardless of an exact shape, the body associated with the sliding contact support devices of the present disclosure (e.g., the support devices 150 (FIG. 3A), 160 (FIG. 3B), 170 (FIG. 3C)) can be configured to provide the corresponding contact surface appropriate for line-type interface with the glass ribbon 22. For example, a width of the contact surface associate with some embodiment sliding contact support devices of the present disclosure can optionally be in the range of 2-25 mm.

Returning to FIG. 1, in other embodiments, one or more of the support device 72 provided with the conveying apparatus 32 is or includes a gas bearing support device. As a point of reference air bearings have previously been considered in the in the transport of thick glass ribbons. With conventional air bearings used with thick glass ribbon handling, there is an intrinsic limitation at the edges of the glass ribbon where the air bearing effect diminishes or even vanishes. To address this problem, a specific design correction is required that either operates to maintain the glass ribbon at a high flying height via high air flow (as with a bearing head having discrete, machined orifices), or at a low flying height via high pressure (as with a porous material bearing head). In both cases, the thermal effect on the glass ribbon can be significant and may not be compatible with a desired cooling rate. In addition, the conventional air bearing design does not preclude the glass ribbon from contacting the head due to, for example, process variations or sequence. Conventional air bearing designs can be even more problematic in the transport of thin glass ribbons. Local cooling by direct contact with the bearing head can be particularly easy given the small thermal mass of the thin glass ribbon as compared to the large heat transfer generated by this heat transfer mode. The coupling between deformation and heat transfer through the exponential dependency of viscosity with temperature can create an oscillating condition that materializes in a wavy ribbon edge. A possible mechanism is that as a contact first occurs, the sudden viscosity increase makes it more difficult for the glass ribbon that follows to touch the cold head; as a result, non-uniform cooling can happen over time, leading to a substantive deformation in the glass ribbon.

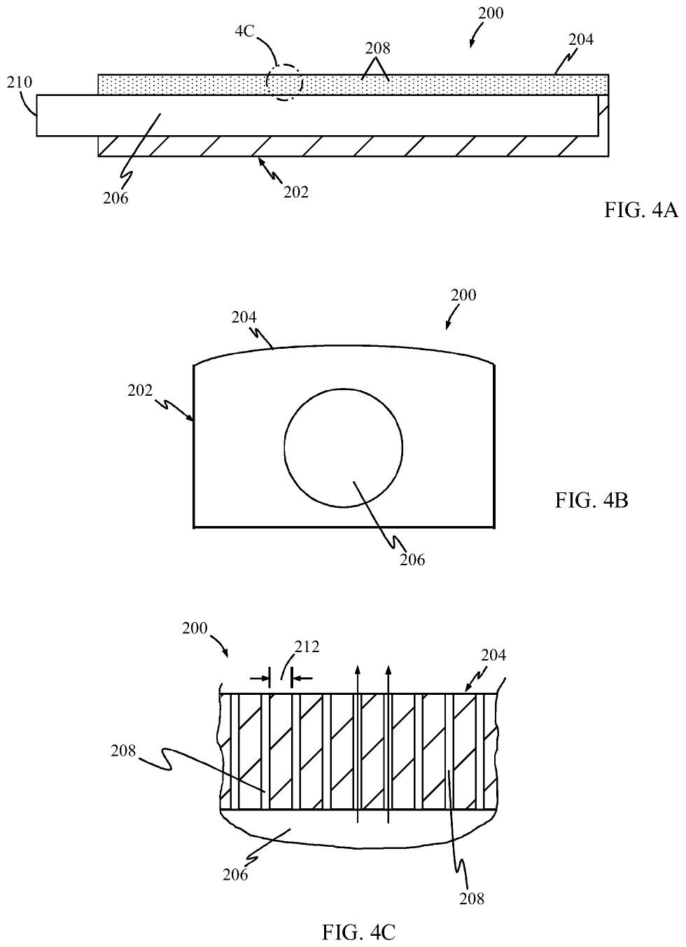

Some embodiments of the present disclosure provide a gas bearing support device that addresses one or more of the above concerns. For example, FIGS. 4A and 4B illustrate a gas bearing support device 200 useful as, or as part of, one or more of the support devices 72 (FIG. 1) of the present disclosure. The gas bearing support device 200 includes a gas bearing head 202 defining a distribution face 204 and forming at least one supply channel 206. A plurality of orifices 208 (referenced generally in FIG. 4A) are formed through a thickness of the head 202, and are open to the distribution face 204 and the supply channel 206. With this construction, pressurized gas supplied to an inlet 210 of the supply channel 206 is distributed as a gas film from the distribution face 204 at levels (e.g., flow rate, pressure, etc.) sufficient to support the glass ribbon 22 (FIG. 1) with a line-type interface.

The orifices 208 can be formed or defined in various manners. In some embodiments, the orifices 208 are machined into the head 202. In other embodiments, construction of the head 202 can generate the orifices 208 (e.g., 3D printing). In yet other embodiments, the head 202, or at least that portion of the head 202 defining the distribution face 204, can comprise a porous material. The porous material can include graphite, ceramic, partially sintered metal, high temperature tolerant metal oxide(s), silicon carbide and other similar material which gas may be flowed at desired pressures (e.g., pressure in the range of 1×10⁵-3×10⁵ pascal (Pa)). In some embodiments, and as best shown in the enlarged view of FIG. 4C, the orifices 208 are in highly close proximity to one another (as a point of reference, gas flow through two of the orifices 208 is shown by arrows in FIG. 4C). For example, in some embodiments, a gap 212 between immediately adjacent ones of the orifices 208 is not greater than 5 mm, alternatively in the range of 1-5 mm, alternatively about 2.5 mm. Other dimensions are also envisioned. The orifices 208 are defined and arranged to generally maximize the points of distribution of gas from the distribution face 204 such that the effect of the resultant gas film is not local. In some embodiments, and as reflected by FIG. 4B, the distribution face 204 can have a slightly convex shape to encourage formation of a slightly convex gas bearing or film for reasons made clear below.

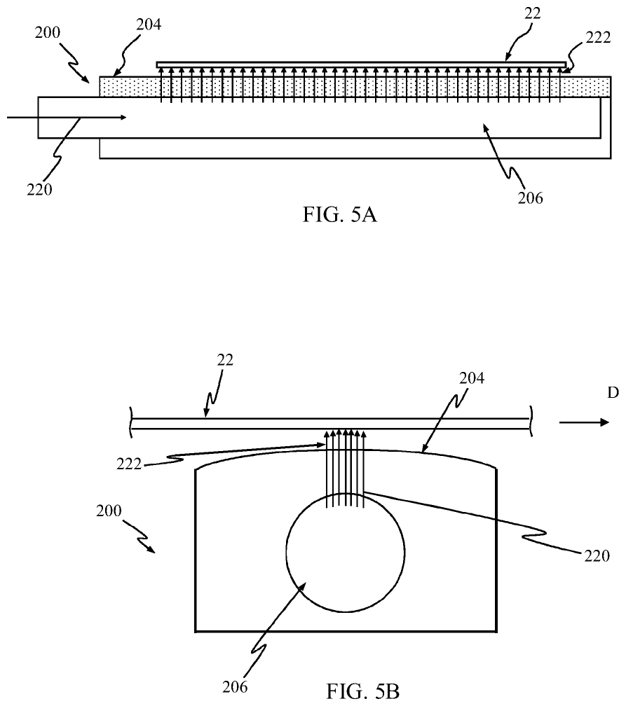

Operation of the gas bearing support device 200 in supporting the glass ribbon 22 is shown in FIGS. 5A and 5B. As a point of clarification, the direction of travel of the glass ribbon 22 in the view of FIG. 5A is into a plane of the page. Pressurized gas 220 (e.g., compressed air, compressed nitrogen, a mixture thereof, etc.) is supplied to the channel 206. In some embodiments, the supplied gas 220 can be heated (e.g., to a temperature of at least 100° C.). Regardless, the orifices 208 (FIG. 4C) direct the gas 220 through the distribution face 204 and toward the glass ribbon 22, forming a gas film 222 that interfaces with and supports the glass ribbon 22. In some non-limiting embodiments, the distribution face 204 can be configured such that an effective shape of the resultant gas film 222 is slightly convex as reflected by FIG. 5B.

Returning to FIG. 1, some methods of the present disclosure can include supplying the glass ribbon 22 to the inlet side 40 of the conveying apparatus 32 as a thin glass ribbon. For example, the glass ribbon 22 as supplied to the conveying apparatus 32 by the glass ribbon supply apparatus 30 can have a thickness of about 1 mm or less. In other embodiments, the glass ribbon 22 as supplied to the conveying apparatus 32 exhibits a thickness in the range from about 0.1 mm to about 5 mm, from about 0.1 mm to about 4 mm, from about 0.1 mm to about 3 mm, from about 0.1 mm to about 2 mm, from about 0.1 mm to about 1 mm, and all ranges and sub-ranges therebetween. In some related, non-limiting embodiments, the glass ribbon 22 can have a width from about 60 mm to about 100 mm. In some related, non-limiting embodiments, the glass ribbon 22 as supplied to the conveying apparatus 32 by the glass ribbon supply apparatus 30 has a viscosity of 10⁸ Poise or less, and is at a temperature of at least 200° C. The glass ribbon 22 is threaded to the pulling device 70, and the pulling device 70 is operated to apply a pulling force onto the glass ribbon 22. The so-applied pulling force causes the glass ribbon 22 to travel through the conveying apparatus 32 along the travel path T as defined, in part, by the support devices 72. In some embodiments, the glass ribbon 22 is caused to travel at a rate or velocity in the range of 1-20 m/min, alternatively 10-15 m/min The glass ribbon 22 cools while traversing from the inlet side 40 to the outlet side 42. While traveling along the travel path T, the glass ribbon 22 interfaces with the support devices 72, with the support devices 72 each establishing a non-rolling, line-type interface with the glass ribbon 22. In some embodiments, the glass ribbon 22 cools and experiences an increase in viscosity when traveling from the inlet side 40 to the outlet side 42.

The glass ribbon processing systems, conveying apparatuses, and methods of the present disclosure can provide a marked improvement over previous designs and techniques. Some systems, apparatuses and methods of the present disclosure include non-rolling interface with a traveling glass ribbon. As compared to conventional glass ribbon conveyor constructions that otherwise employ rollers, the systems, apparatuses and methods of the present disclosure can minimize or remove friction thus minimizes or eliminating a source of surface scratches that can be considered cosmetic defects and/or create flaws that might reduce mechanical strength, and avoids angular and/or velocity mismatch thus removing a source of in-plane compressive stresses that can drive out-of-plane deformation. Further, the non-rolling, line-type glass ribbon interface provided by the systems, conveying apparatuses, and methods of the present disclosure can decrease the likelihood of the thermal scarring.

Various modifications and variations can be made the embodiments described herein without departing from the scope of the claimed subject matter. Thus it is intended that the specification cover the modifications and variations of the various embodiments described herein provided such modifications and variations come within the scope of the appended claims and their equivalents.

What is claimed is:

1. A method for processing a glass ribbon, the method comprising:
supplying a glass ribbon to an upstream side of a conveying apparatus;
applying a pulling force on the glass ribbon at a downstream side of the conveying apparatus;
supporting the glass ribbon at first and second support devices along a travel path of the conveying apparatus from the upstream side to the downstream side;
wherein each of the first and second support devices establishes a non-rolling, line-type interface with the glass ribbon;
and further wherein the first support device is spaced from the second support device along the travel path.

2. The method of claim 1, wherein between at least one of the first and second support devices, the line-type interface comprises a sliding interface.

3. The method of claim 1, wherein between at least one of the first and second support devices, the line-type interface comprising a gas bearing interface.

4. The method of claim 1, wherein a viscosity of the glass ribbon at the upstream side is less than 10⁸ Poise.

5. The method of claim 1, wherein a viscosity of the glass ribbon at the upstream side is less than the viscosity at the downstream side.

6. The method of claim 1, wherein the glass ribbon is not directly supported by the conveying apparatus between the first and second support devices.

7. The method of claim 6, wherein the first support device is spaced from the second support device along the travel path by a distance of not less than 50 mm.

8. The method of claim 6, wherein the first support device is spaced from the second support device along the travel path by a distance in the range of 100-500 mm.

9. The method of claim 1, wherein a line of the line-type interface is substantially perpendicular to a direction of travel of the glass ribbon along the travel path.

10. The method of claim 1, wherein the step of applying a pulling forces comprises conveying the glass ribbon at a travel speed in the range of 1-20 m/min.

11. The method of claim 1, wherein the step of supplying a glass ribbon comprises directing the glass ribbon in a vertical direction to the upstream side.

12. The method of claim 11, wherein the step of supplying a glass ribbon further comprises turning the glass ribbon from the vertical direction to a horizontal direction at the upstream side.

13. A system for processing a glass ribbon, the system comprising:
a conveying apparatus configured to establish a travel path for the glass ribbon from an upstream side to a downstream side, the conveying apparatus comprising:
a pulling device configured to apply a pulling force onto the glass ribbon, the pulling device located proximate the downstream side,
a first support device upstream of the pulling device relative to the travel path,
a second support device between the first support device and the pulling device relative to the travel path,
wherein the first and second support devices are each configured to establish a non-rolling, line-type interface with the glass ribbon,
and further wherein the first support device is spaced from the second support device in a direction of the travel path.

14. The system of claim 13, wherein at least one of the first and second support devices comprises a contact surface having a low coefficient of friction with glass and arranged to establish sliding contact with the glass ribbon.

15. The system of claim 14, wherein the contact surface comprises sintered alpha silicon carbide.

16. The system of claim 13, wherein at least one of the first and second support devices comprises a gas bearing support device.

17. The system of claim 13, wherein the conveying apparatus is characterized by the absence of a support device between the first and second support devices relative to the travel path.

18. The system of claim 17, wherein the first support device is spaced from the second support device in the direction of the travel path by a distance of not less than 50 mm.

19. The system of claim 17, wherein the first support device is spaced from the second support device in a direction of the travel path by a distance in a range of 100-500 mm.

20. The system of claim 13, further comprising a glass ribbon forming apparatus arranged to deliver a glass ribbon to the upstream side.
